(19) United States
(12) Patent Application Publication
(10) Pub. No.: US 2003/0142921 A1
(43) Pub. Date: Jul. 31, 2003

(54) Method of aligning optical fibers in an array member

(76) Inventors: Joseph L. Dallas, Maple Glen, PA (US); Angelique X. Irvin, Radnor, PA (US); Robert W. Irvin, Radnor, PA (US); Ralph S. Jameson, Orefield, PA (US); William A. Mamakos, Laurel, MD (US)

Correspondence Address: CANTOR COLBURN, LLP, 55 GRIFFIN ROAD SOUTH, BLOOMFIELD, CT, 06002

(21) Appl. No.: 10/058,900

(22) Filed: Jan. 28, 2002

(51) Int. Cl. G02B 6/36; G02B 6/00

(52) U.S. Cl. 385/80; 385/83; 385/137

(57) ABSTRACT

The present invention provides a method of fabricating a multi-fiber array in which optical fibers are actively aligned to their target positions. The method includes providing an array member for receiving optical fibers, forming in the array member through-holes, placing the optical fibers in the respective through-holes, applying adhesive into the respective through-holes, adjusting position of each optical fiber so that the optical fibers are aligned in accordance with reference measurements, and curing the adhesive to fix the optical fibers aligned in the respective through-holes.

### BACKGROUND

The present invention relates to an optical fiber array, and more particularly, to a method of fabricating a multi-fiber array where multiple optical fibers are actively aligned in accordance with reference measurements.

Generally, a multi-fiber array has two substrates, such as upper and lower substrates, and multiple optical fibers that are arranged in parallel between the two substrates. Adhesive material is typically used to bond the optical fibers onto one or both of the substrates and also to attach the upper and lower substrates to each other. By arranging the optical fibers between the substrates and bonding them together, the optical fibers should be well aligned to perform efficient light transmission. In a multi-fiber array, accurate alignment of optical fibers (especially, optical fiber cores) is an important factor in determining efficiency of light transmission through the optical fibers. Any deviation in the alignment of optical fiber cores may affect light transmission of a multi-fiber array.

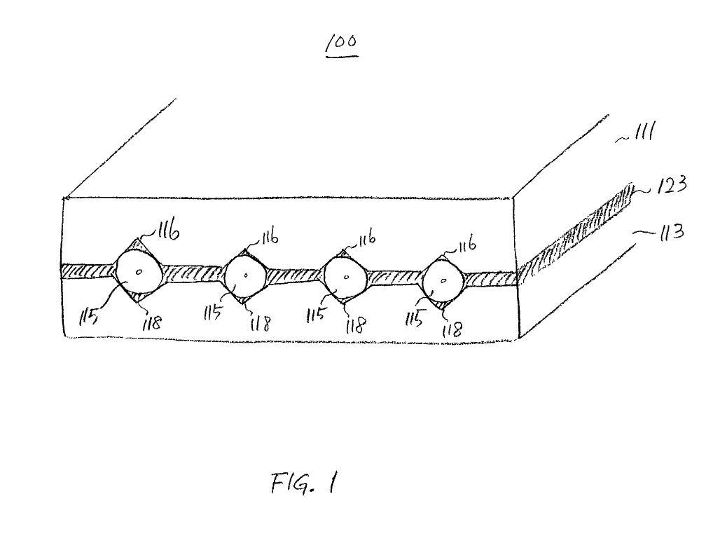

Referring to FIG. 1, a cross-sectional, perspective view is provided for illustrating a typical multi-fiber array 100. Two substrates, upper and lower substrates 111, 113 are stacked, and multiple optical fibers 115 are arranged in parallel between the two substrates 111, 113. As shown in FIG. 1, the upper and lower substrates 111, 113 each have a surface on which V-shaped grooves are formed. The grooves 116 on the bottom surface of the upper substrate 111 are respectively mated with the grooves 118 on the top surface of the lower substrate 113. Each of the optical fibers 115 is placed within a space formed with a pair of matching V-grooves, i.e., a V-groove of the lower plate 113 and a corresponding V-groove of the upper plate 111. The optical fibers 115 are placed between the respective V-grooves 116, 118 of the upper and lower substrates 111, 113 and fixed therein by adhesive 123. Thus, proper alignment of the optical fibers 115 may be maintained by the V-grooves 116, 118. In other words, the position of each optical fiber is determined and maintained by being held with a corresponding pair of V-grooves.

A typical process of fabricating the conventional multi-fiber array 100 is as follows. The upper and lower substrates 111, 113 are separately subjected to a mechanical and/or chemical process to form the V-grooves 116, 118 on the surfaces of the substrates 111, 113. Since the shape of each V-groove determines the position of each optical fiber, precise measurements are required in forming the V-grooves 116, 118. The optical fibers 115 are then mounted on the respective V-grooves 118 of the lower substrate 113.

After placing the optical fibers 115, the adhesive 123 is applied over the lower substrate 113 so that the optical fibers 115 are coated with the adhesive 123. Then, the lower substrate 113 and the optical fibers 115 are housed with the upper substrate 111, which also has corresponding V-grooves 116 on the bottom surface. At this time, the upper substrate 111 is stacked on the lower substrate 113 in such way that each of the V-grooves 116 is mated with corresponding one of the V-grooves 118 in their longitudinal direction. The upper substrate 111 is pressed down toward the lower substrate 113 to be bonded to each other, and the optical fibers 115 are fixed by being tightly confined within the V-grooves 116, 118. As a result, the multi-fiber array 100 is formed in which the optical fibers 115, each having direct contact with the respective V-grooves 116, 118, are arranged between the substrates 111, 113.

Examples of multi-fiber arrays can be found in U.S. Pat. No. 6,215,945 to Fukuyama et al., issued on Apr. 10, 2001, “Optical Fiber Array”; and U.S. Pat. No. 5,790,731 to G. Deveau, issued on Aug. 4, 1998, “Optical Fiber Array/Optical Integrated Circuit Interconnection Assembly and Enclosures for Protecting the Interconnection Assembly”.

However, the conventional multi-fiber array and the fabrication method thereof have drawbacks in that the position of each optical fiber (especially, the optical fiber core) cannot be precisely controlled, thus causing misalignment of the optical fibers. In other words, the optical fibers (or optical fiber cores) may be deviated from their target positions. Major factors causing such deviation or misalignment of the optical fiber cores are as follows.

First, the optical fiber cores may be misaligned due to unevenly applied pressure on the upper substrate. When the upper and lower substrates are bonded to each other by pressing the upper substrate toward the lower substrate, pressure applied on the upper substrate should be maintained evenly over the entire area. Since the position of each optical fiber is determined by being tightly confined within the V-grooves of the substrates, unevenly or incompletely applied pressure on the upper substrate may cause any deviation from the target positions.

Second, misalignment of the optical fiber cores may also be caused by an error in forming the V-grooves on the substrates. As described above, since alignment of the optical fibers is maintained by the V-grooves, the shape of each V-groove should be formed in accordance with precise measurements. In addition, adjacent V-grooves should be spaced relative to each other by a predetermined distance, and each V-groove should have a predetermined height from the bottom of the lower substrate. If there is an error in complying with such measurements, the optical fibers may be misaligned.

Finally, the optical fiber cores may also misaligned due to an error in their concentricity. It is assumed in fabrication of the conventional multi-fiber array that each optical fiber core is centered on the corresponding optical fiber. In practice, however, concentricity of the optical fiber cores may be failed. In this case, the optical fiber cores may be misaligned even though pressure on the upper substrate is evenly applied and the V-grooves are formed in compliance with required measurements.

Therefore, there remains a need for a multi-fiber array and a fabrication method thereof in which optical fibers are aligned in compliance with reference measurements so that cores of the optical fibers are accurately aligned to their target positions.

### BRIEF SUMMARY

The present invention provides a method for fabricating an array of optical fibers. The method comprises providing a substrate for receiving the optical fibers; forming in the substrate through-holes; placing the optical fibers in the respective through-holes; applying adhesive into the respective through-holes, each of the optical fibers being coated with the adhesive in corresponding one of the through-holes; adjusting a position of each optical fiber; and curing the adhesive to fix the optical fibers aligned in the respective through-holes. The substrate may be a unitary substrate having the through-holes into which the respective optical fibers are inserted and the adhesive is injected, or consist of lower and upper plates each having grooves to form the through-holes in which each of the grooves of the lower plate is mated with corresponding one of the grooves of the upper plate to form corresponding one of the through-holes.

The present invention further provides an array of a plurality of optical fibers, comprising a substrate having through-holes each extending in parallel with each other in a longitudinal direction of the through-holes; adhesive filled in the respective through-holes; and the optical fibers placed in the respective through-holes, each of the optical fibers being coated with the adhesive in corresponding one of the through-holes; wherein cores of the optical fibers are aligned in accordance with reference measurements. Preferably, each of the optical fibers has no direct contact with the side wall of corresponding one of the through-holes.

### DETAILED DESCRIPTION OF THE PREFERRED EMBODIMENTS

Some embodiments of the invention will now be described in detail in the following Examples.

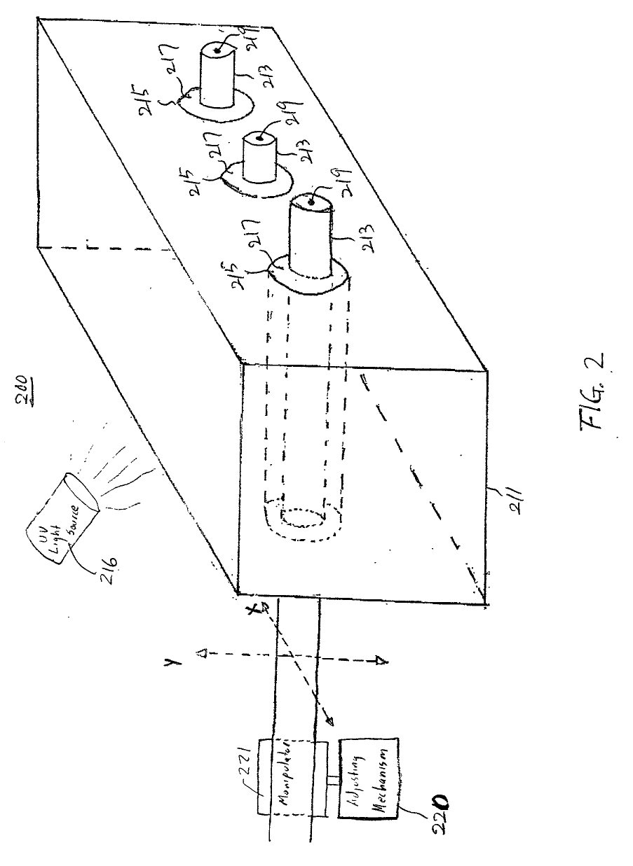

FIG. 2 is a perspective view illustrating a multi-fiber array 200. In the multi-fiber array 200, an array member 211 is provided for receiving multiple optical fibers 213 therein. The array member 211 has through-holes 215 each extending throughout the array member 211 in a direction corresponding to the longitudinal direction of the optical fibers 213. The through-holes 215 are filled with an adhesive 217. Each of the optical fibers 213 is coated, preferably airtightly, with the adhesive 217 in corresponding one of the through-holes 215. Preferably, the optical fibers coated with the adhesive 217 have no physical or direct contact with the inside walls of the respective through-holes 215. Adhesive 217 includes metal solder, glass, heat cured epoxy, UV-cured adhesive, and combinations including one or more of the foregoing. Adhesive 217 is solidified by a curing the adhesive in a manner known in the pertinent art for curing a corresponding adhesive 217. For example, a solder is cured by cooling, heat cured epoxy is cured by heating, while other epoxies may be cured by evaporation or subjecting the epoxy to the atmosphere. In one embodiment, adhesive 217 is a UV-cure adhesive that is exposed to UV (ultraviolet) light from a UV light source 216 to cure adhesive 217. Although it will be recognized that other adhesives can be used with a corresponding curing manner, an embodiment employing UV-cure adhesive 217 and UV-light source 216 as the curing manner will be described hereinafter.

In case that UV-cure adhesive is used as the adhesive 217, the optical fibers 213 are movable in the respective through-holes 215 unless the UV-cure adhesive is exposed to UV light. Before the UV-cure adhesive 217 is solidified by being exposed to UV light, the optical fibers 213 coated with the UV-cure adhesive 217 may be readily adjusted or repositioned to be aligned to their target positions. In this embodiment, a position manipulator 221 is employed to adjust each optical fiber in accordance with reference measurements. When the optical fibers 213 are accurately aligned, the UV-cure adhesive 217 is exposed to UV light to fix the optical fibers 213 in their aligned positions. Thus, each of the optical fibers 213 is actively aligned to its target position and instantly fixed by UV-curing the adhesive 217.

For adjustment of the optical fibers 213, an adjusting mechanism 220 may be employed at either or both sides of the array member 211. The adjusting mechanism 220 preferably has multiple manipulators 221 for adjusting or repositioning the respective optical fibers 213. Each manipulator 221 is associated with corresponding one of the optical fibers 213 to adjust the optical fiber in accordance with reference measurements. For example, a manipulator 221 grasps a corresponding optical fiber and adjusts its position. Preferably, each optical fiber is adjusted in two directions, such as x- and y-directions shown in FIG. 2. In this embodiment, the x- and y-directions are horizontal and vertical directions, respectively, in a surface perpendicular to the longitudinal direction of the through-holes 215.

The reference measurements externally provided to each position manipulator include data representing target position of the core of each optical fiber. Preferably, the reference measurements include data representing height of each optical fiber core from the bottom of the array member 211 and data representing distance between the cores of adjacent optical fibers. Thus, the optical fiber cores 219 may be accurately aligned using each position manipulator to adjust the optical fibers 213 in accordance with the reference measurements to align optical fiber cores 219.

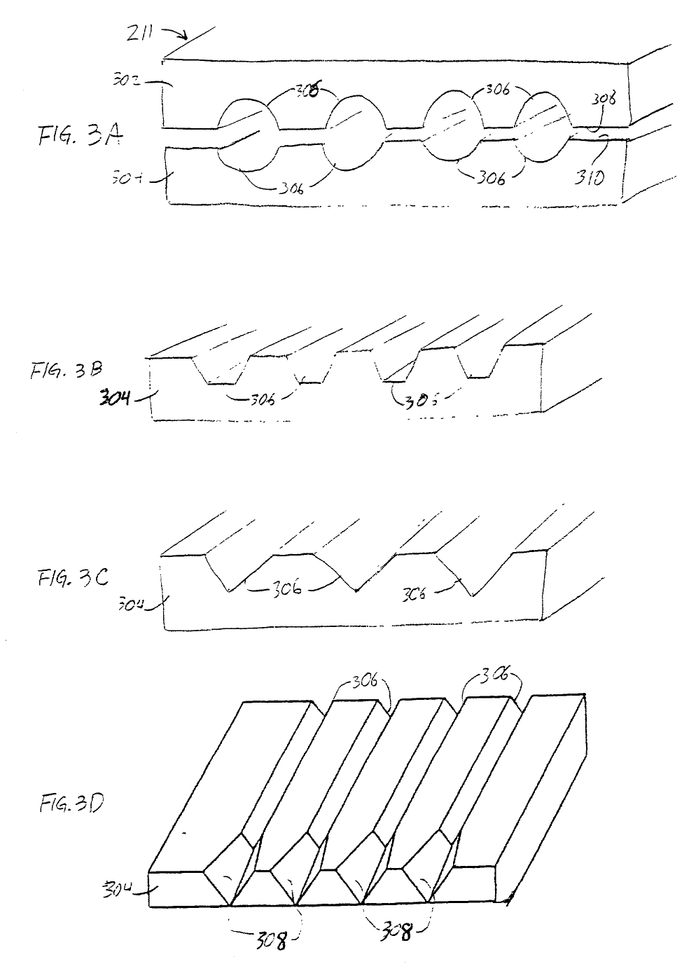

Referring to FIGS. 3A-3D, there are provided perspective views of various types of substrates to be used as array member 211. While the array member 211 shown in FIG. 2 has a unitary structure, an array member 211 employing the substrates shown in FIGS. 3A-3D has two substrates, i.e., upper and lower substrates (or plates) 302 and 304, respectively. It should be noted that shapes of the substrates for the array member 211 are not limited to the exemplary substrates shown in FIGS. 3A-3D.

In case that the array member 211 consists of the upper and lower substrates 302 and 304, each substrate has grooves 306 on its surface. The upper substrate 302 has grooves 306 on the bottom surface 308, and the lower substrate 304 has grooves 306 on the top surface 310. The grooves 306 may have various shapes, for example, FIG. 3D shows modified V-shaped grooves 306 in which each groove 306 has a tapered portion 308 allowing an optical fiber to be inserted more easily into the array member 211.

The upper and lower substrates 302 and 304 are combined with each other in such way that each groove 306 of the upper substrate 302 is mated with corresponding groove 306 of the lower substrate 304. Each pair of the matching grooves forms a through-hole 215 in which an optical fiber 213 is placed and surrounded by the adhesive 217, as shown in FIG. 2. Adjustment and alignment of the optical fibers 213 placed in the respective through-holes 217 formed with the grooves 306 are performed in the same manner as described above.

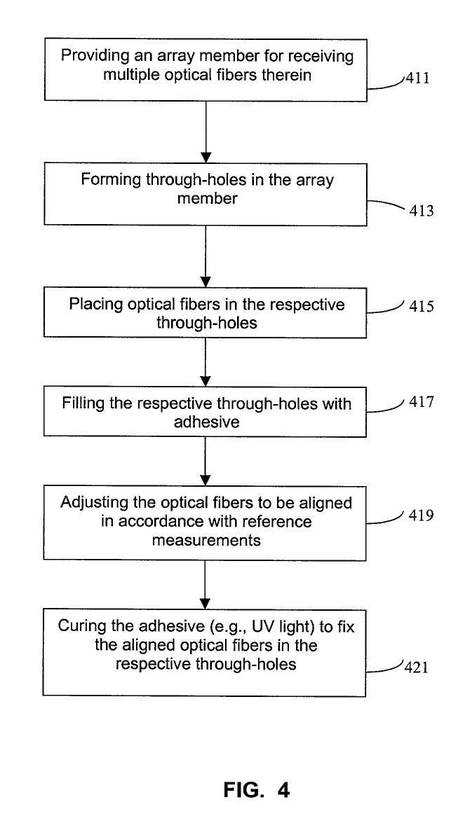

In FIG. 4, a flow chart is provided for describing a method 400 of fabricating a multi-fiber array 200. Referring to FIG. 2 and FIG. 4, method 400 will be described. An array member 211 is provided for receiving multiple optical fibers 213 (step 411). The array member 211 may be a single substrate, as shown in FIG. 2, or consist of two substrates, as shown in FIGS. 3A-3D. Multiple through-holes 215 are formed in the array member 211 (step 413). The through-holes 215 extend in parallel with each other in their longitudinal direction. In case of the unitary substrate, the array member 211 may be molded to have the through-holes 215 or subjected to mechanical or chemical process to form the through-holes 215. The through-holes 215 should have a diameter larger than that of the optical fibers 213. The through-holes 215 are also formed in compliance with predetermined measurements such as distance between adjacent through-holes 215 and height from the bottom of the array member 211.

In case of the array member 211 having two substrates as shown in FIGS. 3A-3D, the through-holes 215 are formed by combining the upper and lower substrates 302 and 304 which have grooves 306 on their opposite surfaces 308 and 310.

The optical fibers 213 are placed in the respective through-holes 215 (step 415). In case of the unitary substrate, the optical fibers 213 are inserted into the respective through-holes 215. Whereas, in case of the array member 211 having two substrates, the optical fibers 213 may be placed on the respective grooves 306 of the lower substrate 304 and then housed with the upper substrate 302. The through-holes 215 are also filled with adhesive 217 (step 417). In case of the unitary substrate, the adhesive 217 may be injected into the respective through-holes 215 either before or after inserting the optical fibers therein. In the case that an UV-cure adhesive is used, the adhesive is protected from UV light at this time. In the case of the dual substrate array member 211, UV-cure adhesive 217 is preferably applied onto the lower substrate 304 before being housed with the upper substrate 302. Also, the adhesive 217 may be applied either before or after placing the optical fibers 213 on the respective grooves 306 of the lower substrate 304. Since UV-cure adhesive 217 has a liquid property until it is exposed to UV light, the optical fibers 213 surrounded with the UV-cure adhesive 217 are movable in the respective through-holes 215. It will be recognized that other adhesives 217 may be used with a corresponding curing manner known in the art and discussed above, instead of using UV-cure adhesive with UV light as the curing manner. The use of UV-cure adhesive with UV light as a corresponding curing manner is merely one embodiment of an adhesive and corresponding curing manner for fabricating a multi-fiber array 200. Adhesive 217 also includes metal solder, glass, heat cured epoxy, and combinations of at least one of the foregoing including UV-cure adhesive. Adhesive 217 is solidified by a corresponding curing manner known in the pertinent art for curing a selected adhesive 217.

The optical fibers 213 are then adjusted in accordance with reference measurements to their target positions (step 419). The optical fibers 213 may be adjusted in predetermined directions, such as horizontal and vertical directions, until their cores 219 are accurately aligned. Such active alignment may be performed selectively or simultaneously with respect to the optical fibers. In case of the selective alignment, the adhesive 217 in the respective through-holes 215 is selectively exposed to a corresponding curing manner. For example, when adhesive 217 is an UV-cure adhesive, UV light is applied to adhesive 217 in individual through-holes 215 in which the optical fibers 213 have been successfully aligned, whereas UV-cure adhesive 217 is protected from UV light in through-holes 215 with optical fibers 213 under adjustment. In the case of simultaneous alignment, the optical fibers 213 are adjusted and aligned at the substantially same time, and UV light is applied to the UV-cure adhesive 217 in all the through-holes 215. By being exposed to UV light, the UV-cure adhesive 217 is solidified to fix the optical fibers 213 in their aligned positions (step 421). Therefore, the cores 219 of the optical fibers 213 are accurately aligned to their target positions so that the efficiency of light transmission in the multi-fiber array is maximized.

To facilitate the UV-curing of the adhesive 217, all or part of the array member 211 may be constructed of a transparent material, such as glass. The transparent material allows the UV-light from UV-light source 216 to reach the UV-cure adhesive 217. Where selective alignment is performed, the array member may be constructed as shown in FIG. 5., with the array member 211 being constructed of a transparent material having opaque dividers 502 disposed intermediate through holes 215. Each opaque divider 502 extends in a plane parallel to the centroidal axes of the adjacent through holes 215 and prevents UV light applied to the UV-cure adhesive 217 in one through hole 215 from reaching UV-cure adhesive 217 in the adjacent through hole(s) 215.

The method described herein allows optical fibers to be accurately positioned in an array member. In the method described herein the fibers are actively aligned, ensuring accurate alignment of the fiber cores regardless of errors in the fabrication of the optical fiber or the reference surface (e.g. the substrate).

Having described preferred embodiments of an apparatus and method of aligning optical fibers to waveguides, modifications and variations can be readily made by those skilled in the art in light of the above teachings. It is therefore to be understood that, within the scope of the appended claims, the present invention can be practiced in a manner other than as specifically described herein.

1. A method for fabricating an array of optical fibers, comprising the steps of:
providing a substrate for receiving the optical fibers;
forming in the substrate through-holes;
placing the optical fibers in the respective through-holes;
applying adhesive into the respective through-holes, each of the optical fibers being coated with the adhesive in corresponding one of the through-holes;
adjusting a position of each optical fiber after said placing the optical fibers in the respective through holes and after said applying adhesive into the respective through holes; and
curing the adhesive to fix the optical fibers in the respective through-holes.

2. The method of claim 1, wherein the through-holes are formed to be spaced from each other by a predetermined distance.

3. The method of claim 2, wherein the through-holes are formed to have a substantially same distance from the bottom of the substrate.

4. The method of claim 1, wherein the adhesive is a metal solder, glass, heat cured epoxy, UV cured adhesive, or a combination comprising at least one of the foregoing.

5. The method of claim 1, wherein the adjusting step comprises:
grasping an optical fiber with a position manipulator; and
adjusting the optical fiber in a first direction to be aligned in accordance with the reference measurements.

6. The method of claim 5, further comprising adjusting the optical fiber in a second direction to be aligned in accordance with the reference measurements.

7. The method of claim 6, wherein the first direction is one of vertical and horizontal directions in a surface perpendicular to the longitudinal direction of the through-holes, and the second direction is the other of the vertical and horizontal directions.

8. The method of claim 1, wherein the adhesive includes a UV-cured adhesive; and means are includes for protecting the UV-cure adhesive from UV light during the adjusting step.

9. The method of claim 8, wherein the UV-cure adhesive in all the through-holes is exposed to the UV light in case that all the optical fibers are aligned at a same time.

10. The method of claim 8, wherein the UV-cure adhesive in each of the through-holes is selectively exposed to the UV light in case that each of the optical fibers is separately aligned.

11. The method of claim 1, wherein the reference measurements include data representing target positions of cores of the respective optical fibers.

12. The method of claim 11, wherein the reference measurements include data representing distance between the core of each optical fiber and the bottom of the substrate.

13. The method of claim 12, wherein the reference measurements further include data representing distance between the cores of adjacent optical fibers.

14. The method of claim 1, wherein the substrate is a unitary substrate having the through-holes into which the respective optical fibers are inserted and the adhesive is injected.

15. The method of claim 1, wherein the substrate has lower and upper plates each having grooves to form the through-holes, each of the grooves of the lower plate being mated with corresponding one of the grooves of the upper plate to form corresponding one of the through-holes.

16. The method of claim 15, wherein each of the grooves of one or both of the lower and upper plates has a tapered portion so that each of the through-holes has an enlarged inlet portion into which an optical fiber is inserted.

17. An array of a plurality of optical fibers, comprising:
a substrate having through-holes each extending in parallel with each other in a longitudinal direction of the through-holes;
adhesive filled in the respective through-holes; and
the plurality of optical fibers placed in the respective through-holes, each of the optical fibers being coated with the adhesive in corresponding one of the through-holes;
wherein cores of the optical fibers are aligned in accordance with reference measurements.

18. The array of claim 17, wherein the through-holes are spaced each other to have a predetermined distance between adjacent through-holes.

19. The array of claim 18, wherein the through-holes each have a substantially same distance from the bottom of the substrate.

20. The array of claim 17, wherein the adhesive includes one of metal solder, glass, heat cured epoxy, and UV cured adhesive, and combinations including at least one of the foregoing.

21. The array of claim 17, wherein each of the optical fibers has no direct contact with side wall of corresponding one of the through-holes.

22. The array of claim 17, wherein the substrate has a unitary structure having the through-holes.

23. The array of claim 17, wherein the substrate has lower and upper plates each having grooves to form the through-holes, each of the grooves on the lower plate mating with corresponding one of the grooves on the upper plate to form corresponding one of the through-holes.
